(19) United States
(12) Patent Application Publication
(10) Pub. No.: US 2016/0072663 A1
(43) Pub. Date: Mar. 10, 2016

(54) Robust Routing of Data in Wireless Networks

(71) Applicant: University College Cork - National University of Ireland, Cork, Cork (IE)

(72) Inventors: Cormac J. Sreenan, County Cork (IE); Jonathan Benson, Dublin (IE); Utz Roedig, Lancaster (GB)

(21) Appl. No.: 14/858,252

(22) Filed: Sep. 18, 2015

Related U.S. Application Data
(63) Continuation of application No. 12/739,277, filed on Aug. 19, 2010, now abandoned.
(60) Provisional application No. 60/960,945, filed on Oct. 22, 2007.

(51) Int. Cl. H04L 12/24; H04L 12/751; H04L 12/721

(52) U.S. Cl. CPC H04L 41/0654; H04L 45/32; H04L 45/02

(57) ABSTRACT

A wireless network (1) comprises a base station (2) and sensor nodes (3). The base station (2) comprises a network interface (10), an application interface (11), topology control functions (12) a timer (13), and a buffer (14). Each sensor node (3) comprises a network interface (20), route control functions (21), processing functions (22), sensors (23), flood mechanism programs (24), tree mechanism programs (25), and data forwarding programs (26). The network operates by establishing a conventional routing tree from the sink node that is used when the network is stable. But when a sending node detects a node or link failure it dynamically switches to sending its data packets using a flooding mechanism, rather than waiting for the routing tree to be re-established. This reduces the latency for data delivery. Also, when flooding the data packets, it allows the packets to be flooded to nodes that are an equal number of hops from the sink node as the send node is from the sink node. This approach is suitable in situations where an obstacle causes the path between the sending node and the sink to be blocked, thus requiring a strategy in which packets are routed by less direct means. It increases the probability of delivery.

### FIELD OF THE INVENTION

The invention relates to routing of data such as sensor data in wireless networks.

### PRIOR ART DISCUSSION

In many wireless sensor networks data is generated by the nodes and has to be forwarded to a given base-station. Generally, data is forwarded in a hop-by-hop fashion as nodes cannot communicate directly with the base-station. A “routing mechanism” is used to decide on which path(s) to use. The routing mechanism itself forms and uses a network topology which is constrained by the available communication links between nodes.

Most available routing mechanisms assume stable links between nodes. However, experiments show that wireless networks have a high fluctuation in link quality. Links might become frequently unavailable (or available) for longer time periods. The following two examples show conditions in which such link quality fluctuation is experienced.

A sensor network is used to monitor car park spaces, in which sensors are deployed on the ground in a parking lot and can detect the presence of a car. Due to the presence or absence of cars and the fact that nodes are deployed on the ground level, link availability fluctuates heavily. Therefore it is impossible to build a stable routing topology.

In another example, a sensor network is used to monitor maritime life. Sensors are attached to buoys monitoring water conditions. Depending on the condition of the sea (waves), link availability between neighbouring buoys might change frequently. Again, it is impossible to obtain a constant routing topology.

Many routing protocols for sensor networks use a tree topology. The tree is formed by exchanging messages among nodes before data forwarding begins. The tree is normally formed in a way that each node can reach the base-station on the shortest possible path. However, due to the wireless channel characteristics (e.g. interferences), a link between two nodes used in the tree might become (temporarily) unavailable. Hence, data forwarding to the base station for nodes located below the broken link is not possible. Different mechanisms can be used to solve this problem. For example, the tree building process can be re-initiated to re-build a fully connected tree. Alternatively, each node in the tree can maintain a list of alternative parent nodes to use in case of link failures. The first solution is problematical as a broken link has to be detected before re-building can be initiated. Between detection and re-building packets cannot be forwarded. Also, tree-rebuilding might be frequently required, leading to a high network activity unrelated to data forwarding. The second solution is problematical as it increases the routing protocol complexity. Deployment and debugging in real-world scenarios would be difficult. Furthermore, alternative routes might also fail.

US2002/0150043 (Perlman et al) describes packet routing in which a packet which has not bee seen before is routed to all neighbouring nodes except the node from which the packet was received.

WO97/50211 (MCI Communications Corp.) describes use of a flooding technique to repair broken links.

U.S. Pat. No. 5,007,052 (Flammer) describes use of sequence numbers at nodes to reduce traffic when employing a flooding mechanism.

The invention is therefore directed towards providing improved routing of data in real time.

### SUMMARY OF THE INVENTION

According to the invention, there is provided a wireless network comprising a plurality of nodes having transmitters and receivers and being interconnected by links, the nodes being adapted for sending data so that it is routed through the network, wherein at least some nodes comprise means for:
using either a routing mechanism based on a stored network topology or a flooding mechanism for sending data to a destination node in the network, and dynamically switching in real time for data delivery from the routing mechanism to the flooding mechanism if a link failure is detected.

In one embodiment, said nodes comprise means for dynamically employing the flooding mechanism without topology re-build allowing for use of the routing mechanism on the next occasion.

In one embodiment, the flooding mechanism of at least some nodes directs data laterally to nodes which are an equal number of links from a sink node as the sending node.

In one embodiment, at least some nodes maintain a count indicating lateral transmissions. In one embodiment, the lateral transmission count is included with transmitted data, and a receiving node is adapted to decide to re-transmit if the lateral count does not indicate that there have been an excessive number of lateral transmissions. In one embodiment, the lateral count is updated with each transmission. In one embodiment, the lateral count is updated by decrementing it if a lateral transmission is made.

In one embodiment, said receiving node is adapted to decide according to comparison of the lateral count value with a threshold which is common across all of the nodes.

In another embodiment, said receiving node is adapted to decide according to comparison of the lateral count value with a threshold which is per-node, being set according to the number of hops between the node and a destination node.

In one embodiment, said receiving node is adapted to determine the threshold according to the number of hops to the destination node for the data.

In one embodiment, at least some nodes comprise means for maintaining a link-break counter and at least some nodes are adapted to automatically perform topology re-build if the link-break parameter value is exceeded. In one embodiment, the link-break parameter is per node and said nodes are adapted to update the counter upon each detection of a link break.

In one embodiment, the parameter is time, topology discovery being performed periodically. In one embodiment, said nodes maintain a sequence number of a current valid topology.

In one embodiment, at least some nodes are adapted to detect a link break if an acknowledgement is not received from a node to which it has sent data.

In one embodiment, at least some nodes maintain a variable, h, of the distance in links between the node and another node, and for using said parameter for the routing mechanism. In one embodiment, the other node is a base station.

In one embodiment, at least some nodes store an address of a parent node and means for using said address for the routing mechanism.

In one embodiment, the network comprises a base station node adapted to manage topology maintenance for the nodes.

In one embodiment, the base station node is adapted to transmit to each node via the network an address of a parent node and a maximum hop distance to the base station node.

In one embodiment, at least some nodes incorporate sensors and means for sending sensed data, and at least one node is a base station for collecting said data.

In one embodiment, the network comprises means for changing from a full mode in which there is dynamic switching from a routing mechanism to a flooding mechanism, to a flooding mode in which a flooding mechanism is always employed. In one embodiment, the flooding mechanism of the flooding mode is a restricted flooding mechanism in which there is no topology re-building. In one embodiment, the network is adapted to change to the flooding mode if an excessive number of link failures are detected. In one embodiment, at least one node is adapted to change mode individually on a per-node basis.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 illustrates a sensor network;

FIG. 2 illustrates base station components;

FIG. 3 shows sensor node components;

FIG. 4 is a flow diagram illustrating base station operation;

FIG. 5 illustrates flow for receiving a topology discovery message;

FIG. 6 illustrates flow for receiving a topology discovery message with local rebuild enabled;

FIG. 7 illustrates flow for receiving a sensor message with lateral transmission enabled;

FIG. 8 illustrates receiving a sensor message with both lateral transmission and local rebuild enabled; and

FIG. 9 illustrates flow for forwarding sensor messages.

### DESCRIPTION OF THE EMBODIMENTS

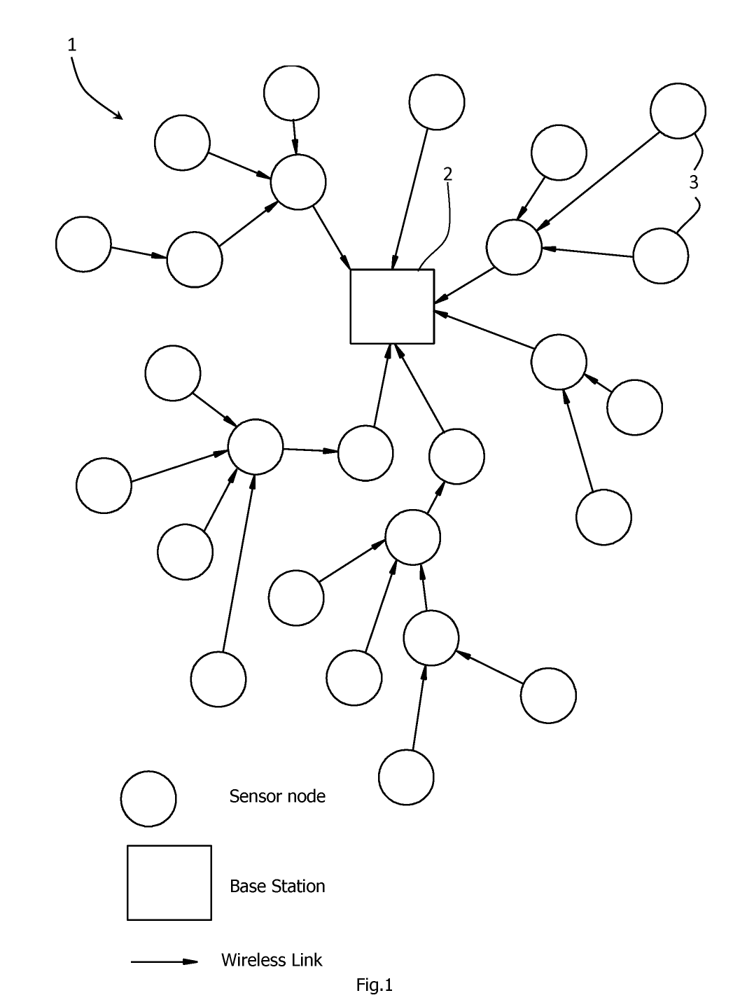

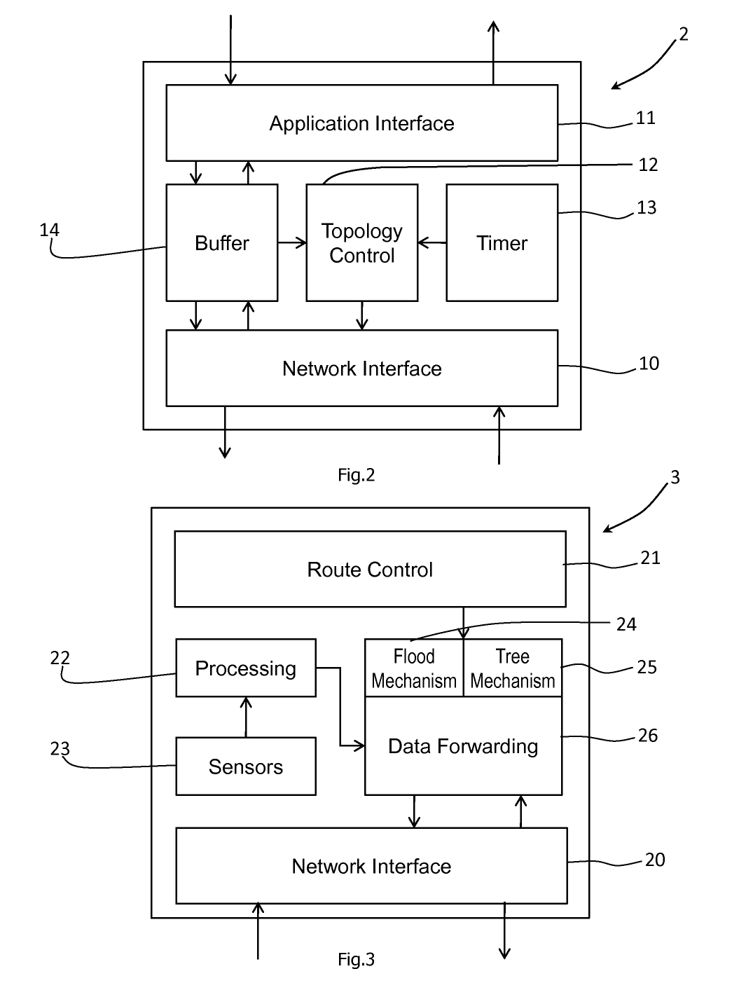

Referring to FIG. 1 a wireless network 1 comprises a base station 2 and sensor nodes 3. Wireless links are shown by arrows. As shown in FIG. 2, the base station 2 comprises a network interface 10, an application interface 11, topology control functions 12 a timer 13, and a buffer 14. Referring to FIG. 3, each sensor node 3 comprises: a network interface 20, route control functions 21, processing functions 22, sensors 23, flood mechanism programs 24, tree mechanism programs 25, and data forwarding programs 26.

In summary, the network operates by establishing a conventional routing tree from the sink node that is used when the network is stable. But when a sending node detects a node or link failure it dynamically switches to sending its data packets using a flooding mechanism, rather than waiting for the routing tree to be re-established. This reduces the latency for data delivery. This dynamic switching aspect is advantageous. Also, when flooding the data packets, it allows the packets to be flooded to nodes that are an equal number of hops from the sink node as the send node is from the sink node. This is different to directed flooding approaches in which packets are only handled by nodes that are closer to the destination. This approach is suitable in situations where an obstacle causes the path between the sending node and the sink to be blocked, thus requiring a strategy in which packets are routed by less direct means. It increases the probability of delivery.

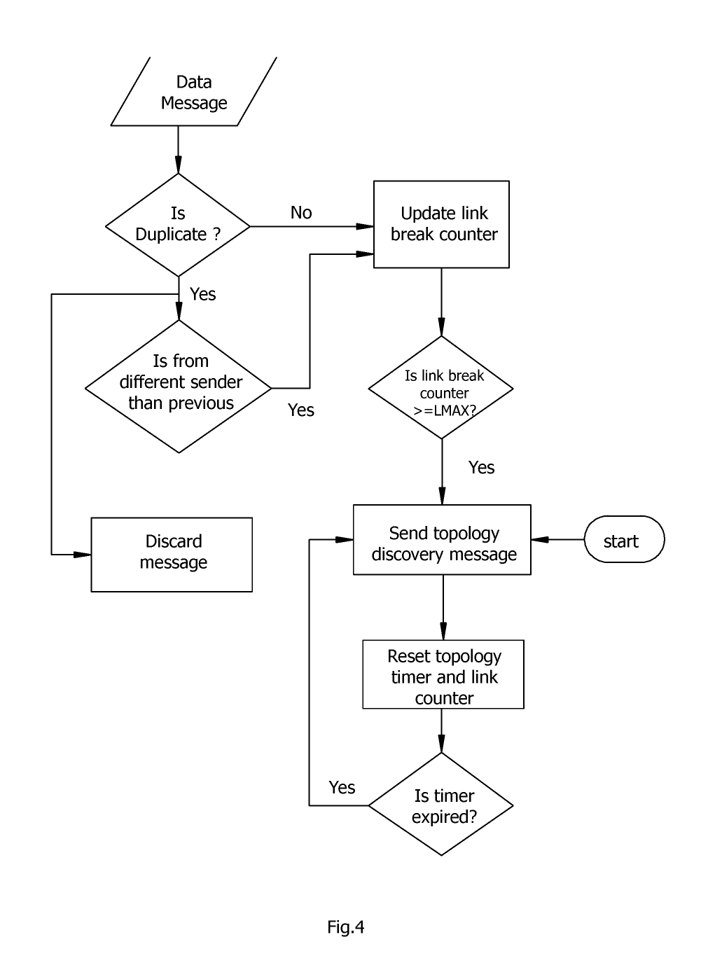

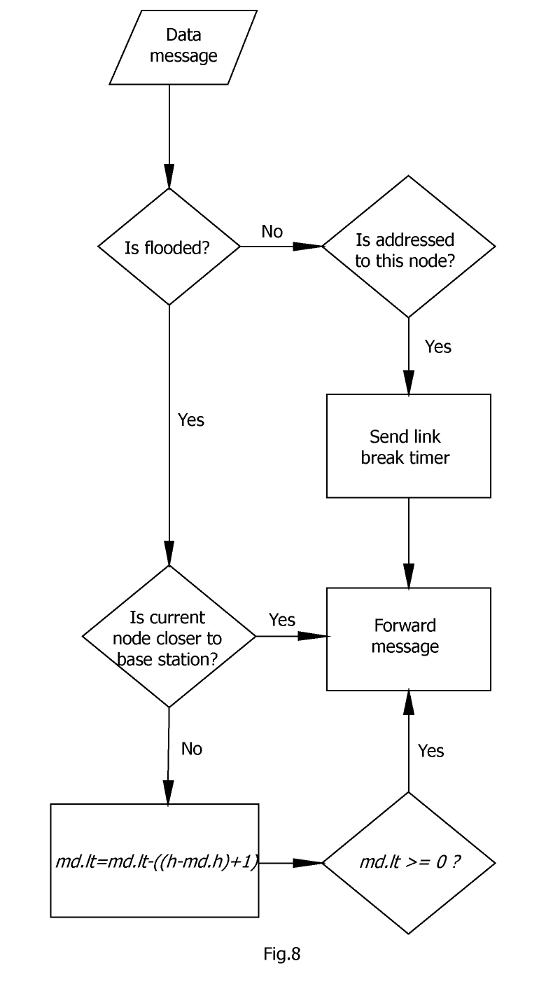

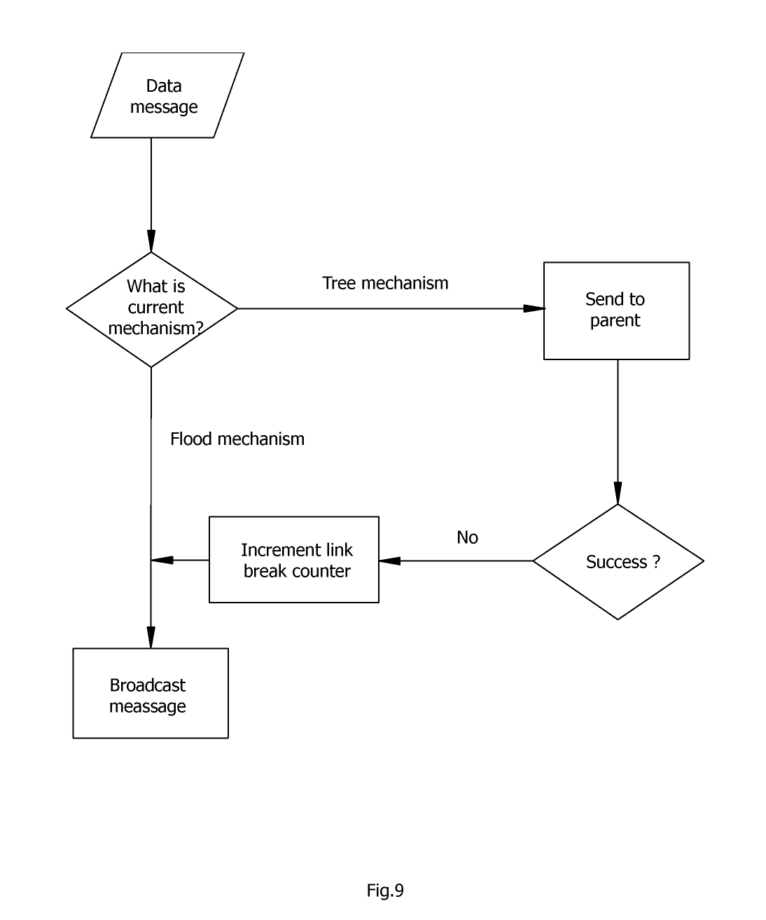

In more detail, and referring also to the flow diagrams of FIGS. 4 to 9, the protocol consists of two phases: topology discovery and data forwarding. For each step dedicated messages are used (called topology mt and data and messages). The variables needed in each node and the two phases are described below.

The protocol forms a tree structure that is used to forward messages to the base-station 2. A node will try to transmit a message to its parent node in the tree. If this fails—indicated by a missing ACK (acknowledgement packet) from the parent node—the node will send the message as broadcast to all neighbouring nodes. There are a number of alternative methods of detecting a broken or poor link aside from missing acknowledgements. For example if traffic between a node pair is bi-directional a timer running since the last message was received for that neighbour can be used to detect that the link has failed. Alternatively signal data (RSSI, SNR, etc.) can be recorded and used to determine if the link quality has become sufficiently bad that the link is essentially unusable. A neighbouring node will only process this message if it considers itself to be closer to the base-station 2 or if it cannot determine its distance to the base-station (un-initialised node). Thus, a directed and selective flooding mechanism is implemented. The distribution of a data packet as broadcast is recorded in the packet itself. The base-station 2 uses this counter in incoming packets to decide if a new round of topology discovery must be initiated.

### Routing Algorithm

### Local Variables

Each node 3 stores a set of variables that are needed to operate the routing algorithm. The variable s contains the sequence number of the current valid topology. When the base-station initiates a new topology discovery phase a new sequence number is used and nodes should always use topology-forming messages carrying the highest sequence number (i.e. the most recent topology discovery phase). The variable h stores the distance in hops of the node to the base-station. This value is obtained during the topology discovery process. Initially h is set to −1 and is updated upon receipt of a topology discovery message. The variable p contains the address of the parent node in the tree. p is obtained during the topology discovery process. If p is set to NULL this indicates that the node has not yet received a topology discovery message. In this case the node is considered un-initialised. A variable MAXtx stores the maximum amount of attempts to send a message using a tree (“routing”) mechanism that a node can make before switching to a flood mechanism. This variable can be set at compile time but it is possible to set this dynamically using the Topology Discovery Message mt. A node may also be able to infer which value to use based on network conditions. The set of necessary routing variables and their initialisation values is shown in Algorithm. 1 below.

Algorithm 1 Routing variables (Implemented in each node)

Routing Variables {

s = − 1
h = − 1
p = NULL
MAXtx =<predefined>

}

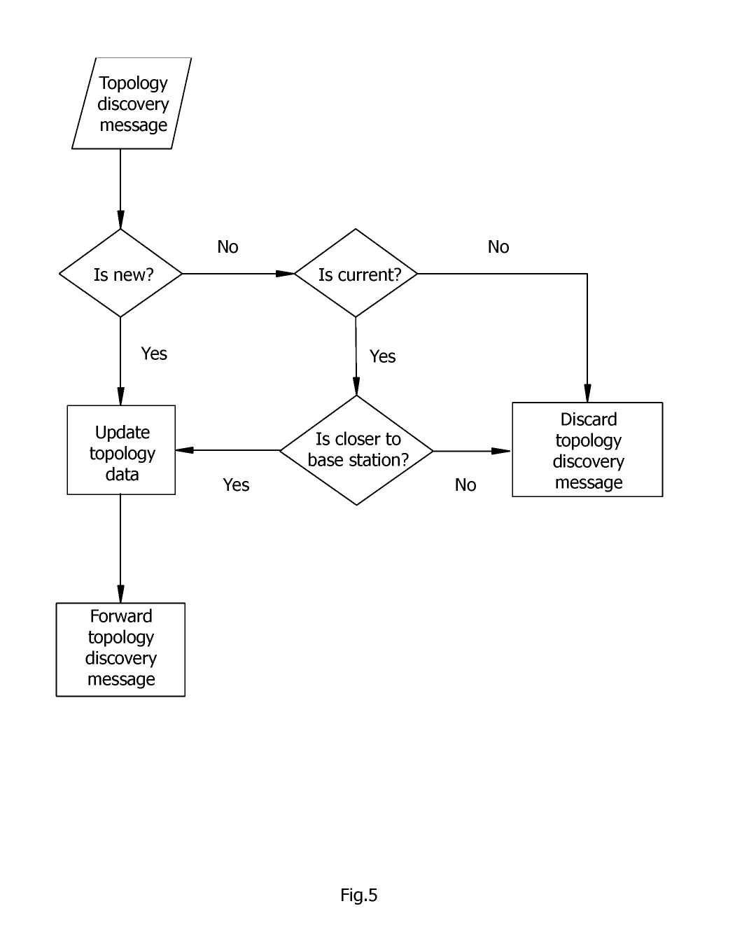

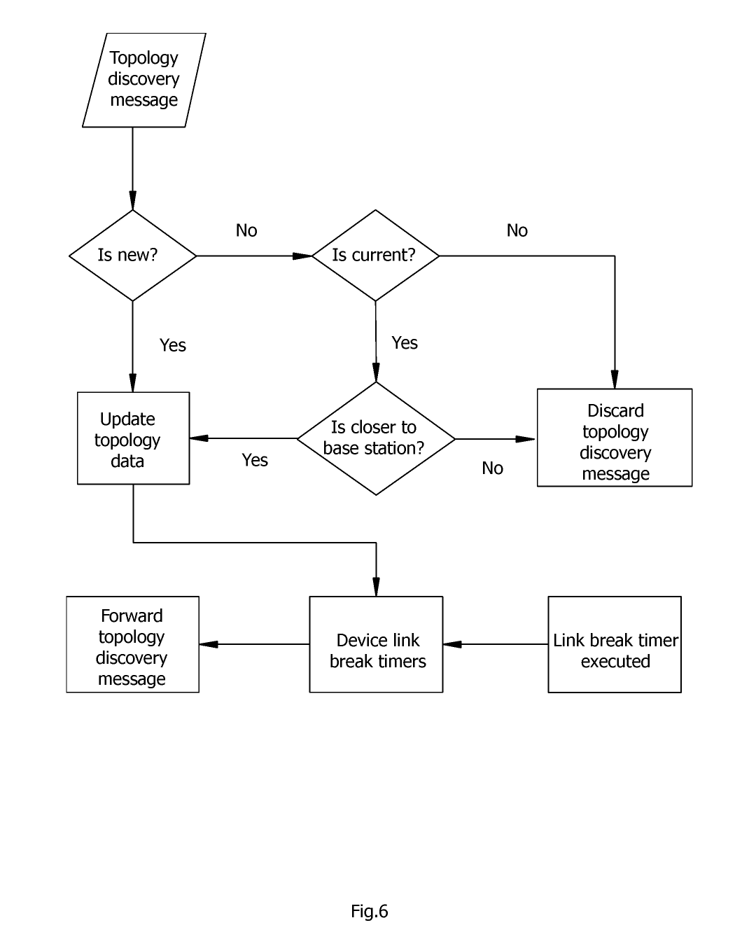

### Topology Discovery to Establish the Routing Mechanism (FIGS. 5 and 6)

The base-station 2 broadcasts a topology message mt using the function TopologyDiscovery(Message mt). The message contains (among other fields not used for routing) the sender address mt.sa and receiver address mt.ra, a hop-counter mt.h, and a unique sequence number mt.s. The hop-counter is initially set to zero (mt.h=0).

Each node receiving this broadcast checks first if the message sequence number is equal to the currently valid topology (if mt.s=s, then a message belonging to the current topology forming process was previously received). If this is the case, it is tested if this message travelled a shorter path from the base station to the current node (mt.h<h). If so, the new shorter hop distance to the base-station is memorised (h=mt.h) and the sender node of the message is memorised as the new parent node in the tree (p=mt.sa). Subsequently, the information in the message is updated and the message is re-broadcasted (mt.s a=localaddr, mt.ra=bcaddr, mt.h=mt.h+1). If the message travelled an equal or longer path, the message is silently discarded.

If the sequence number is greater than the current valid topology (mt.s>s), the topology information in the received message is memorised as it is the most up-to-date information. The currently valid topology is memorised, s=mt.s. The new hop distance to the base station is memorised (h=mt.h) and the sender node of the message is memorised as the new parent node in the tree (p=mt.sa). Subsequently, the information in the message is updated and the message is re-broadcasted (mt.sa=localaddr, mt.da=bcaddr, mt.h=mt.h+1).

Thus, a tree topology is formed in the network and each node knows the address of the parent node p and the hop-distance h to the base-station. The topology discovery process is shown in Algorithm. 2 below.

Algorithm 2 Topology discovery (Implemented in each node)

TopologyDiscovery(Message mt)

if (mt.s = s)

if (mt.h < h)

h = mt.h
p = mt.sa
mt.sa = localaddr
mt.da = bcadr
mt.h = mt.h + 1
send(mt)

else

delete(mt)

else if (mt.s > s)

s = mt.s
h = mt.h
p = mt.sa
mt.sa = localaddr
mt.da = bcaddr
mt.h = mt.h + 1
send(mt)

else

delete(mt)

### Data Forwarding

An incoming data message md is first processed by the function DataIncoming(Message md) which might call subsequently DataForwarding(Message md) to route the data message. If a node creates a data message md itself, the function DataForwarding(Message md) is called directly.

The data message md contains (among other fields not used for routing) the sender address mt.sa and receiver address mt.ra, the hop distance md.h of the last node that processed the message, a link-break-counter mt.l, and a unique sequence number mt.s (mt.s might be a combination of a monotonic increasing number and the node identifier to obtain a globally unique number). The hop distance is set initially to the hop distance of the current node to the base-station (md.h=h). The link-break-counter is initially set to zero (mt.l=0).

An incoming data message, md, is processed by the function DataIncoming(Message md). It is first checked if the message was previously processed by the node using the sequence number mt.s. If so, the message is silently discarded. If the message was not processed before, it is checked if the hop distance of the previous node (md.h) is greater than the hop distance of the current node. If this is the case the data message is forwarded using DataForwarding; otherwise, the message is discarded.

In DataForwarding it is checked if the node has a valid parent node (p≠NULL). If so, the hop distance of the current node is recorded (md.h=h) and DataForwardingTreeMechanism is called which will try to forward the message to the parent node. If the parent node is not known, the node is un-initialised (no topology building message was yet received) and the function DataForwardingFloodMechanism is called directly which will try to deliver the message using flooding. As the distance to the base-station is not known (node is un-initialised), the hop distance in the packet is set to a HMAX representing the maximum possible hop distance in the application scenario.

DataForwardingTreeMechanism (or “routing mechanism”) first updates the sender and receiver fields in the message. The destination address is the parent node in the tree. A temporary variable transmission is created to keep track of the number of transmissions used. A timer is created that will call the function ACKTimerExecuted in the time given by t_{ack}. Subsequently the message is sent and the MAC layer is informed that an acknowledgement for the message is required. Such functionality is provided by most transceivers used in wireless sensor networks. If the message md is not acknowledged by the receiving node in time t_{ack}, the function ACKTimerExecuted is executed which either retries the transmission or if the variable MAXtransmissions is exceeded calls the function DataForwardingFloodMechanism which will try to deliver the message using a directed flooding mechanism. If the acknowledgement is received in time, the running timer for and is simply deleted.

DataForwardingFloodMechanism first updates the sender and receiver fields in the message. Thereafter, the link-break-counter is incremented to indicate that the message could not be delivered through the tree structure in the routing mechanism. Then, the message is sent without using the acknowledgement mechanism.

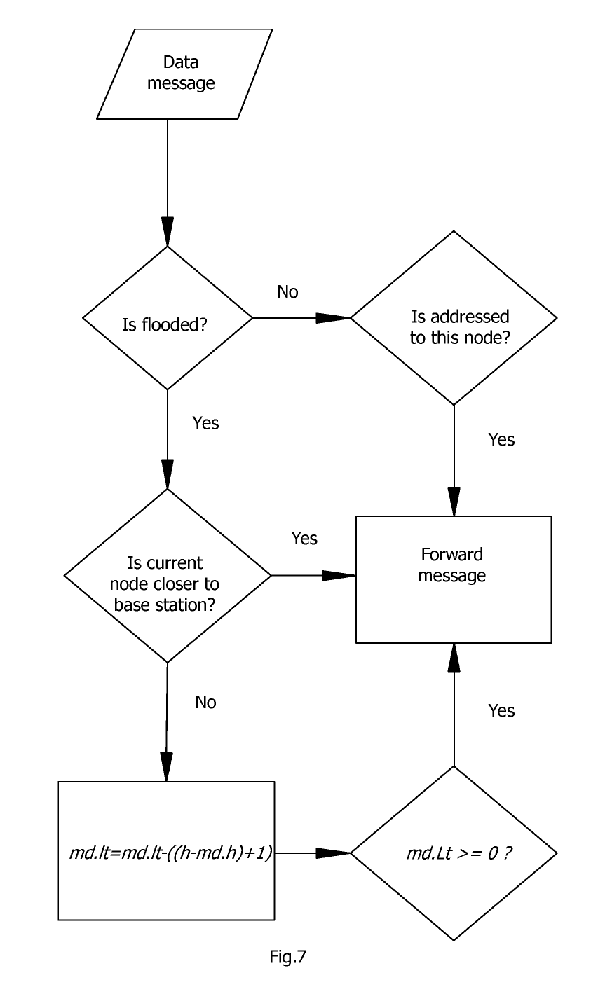

Directed Flooding with Lateral transmission (FIG. 7)

In this embodiment, the protocol allows messages to fan-out laterally for directed flooding. To achieve this, an extra variable, md.lt, is included in each packet (lt signifies lateral transmission). Each time a lateral transmission occurs md.lt is decremented by 1. Should a transmission to a node further away from the current node occur md.lt is decremented by the relative hop difference plus 1, (h−md.h)+1. In order for a message to be transmitted the value of md.lt must be zero or greater after the operation, otherwise the packet will be discarded. In this manner duplicate messages can lateral transmission for a limited amount of hops to nodes both further away and equidistant from the base-station before resuming a direct course towards the base-station. This approach has clear advantages over alternative approaches. Firstly, it is extremely simple. Secondly, it is extremely robust to changing network conditions and does not rely on each node maintaining routing state tables for its neighbours, which is a considerable overhead. Thirdly, it is a far more energy efficient approach compared to simple flooding as the messages are limited in the scope of their flood. Finally, the behaviour of the lateral transmission mechanism is highly configurable.

Algorithm 3 Data Forwarding (Implemented in each node)

DataIncoming(Message md)

if (md is duplicate)

delete(md)

else if (md.h > h)

DataForwarding(md)

else

delete(md)

DataForwarding(Message md)

if (p ≠ NULL)

md.h = h
DataForwrdingTreeMechanism(md)

else

md.h = HMAX
DataForwardingFloodMechanism(md)

DataForwardingTreeMechanism(Message md)

md.sa = localaddr
md.da = p
new AckTimer(t_{ack},md)
send(mt, ACK)

DataForwardingFloodMechanism(Message mt)

md.sa = localaddr
md.da = bcaddr
md.l = md.l + 1
send(mt)

ACKTimerExecuted(Message md)

if (transmissions >= MAXtx)

DataForwardingFloodMechanism(md)

else

transmissions = transmissions+1
DataForwardingTreeMechanism(md)

ACKMessageReceived(Message md)

deleteACKTimer(md)

There are a number of methods and approaches for assigning a “good” value for md.lt. Naturally there is a conflict between optimising for energy and reliability that must be resolved. A high value for md.lt will cause excessive lateral transmission and energy expenditure from redundant transmissions. A low value for md.lt will result in a decrease in the overall reliability obtained by flooding.

A globally common value for md.lt can be used. This method is reliant on a correct assessment of the network reliability prior to deployment and has the advantage of simplicity. Another approach is to increase md.lt with respect to hop distance from the base station. Thus, a node further away from the base station will have a greater md.lt value compared to another node which is closer to the base station. This is because a message that must traverse many hops is more likely to encounter adverse network condition than one that must traverse fewer hops. Again a correct assessment of the network reliability must be made along with an analysis of how reliability varies with respect to hop distance. Finally it is possible to endow the network and the nodes therein with a heuristic so that it can effectively learn the correct value for md.lt at each individual node.

### Base-Station Operation

### Base-Station Variables

The base station stores a link-break-counter l. The counter is used to determine when the topology used in the network should be refreshed.

### Topology Re-Building

Because the nodes dynamically invoke a flooding mechanism in real time there is a strong likelihood that duplicate packets will arrive at the base station, or any sink node. Therefore the base station dynamically performs topology re-building for the entire network, so that the routing mechanism (which is more efficient) is more effective. In fact, by the invention's flooding of data packets dynamically in response to detection of link failures, there is a learning process for the base station to trigger topology maintenance. An incoming data message, md, is first processed by the function DataIncoming(Message md). It is first checked if the message is a duplicate; duplicates are silently discarded. Duplicates can be detected using the md.s field. A message generated at node A and forwarded to the base station over disjoint paths (i.e. one message arrived at the base-station via node B, md.sa=B, and the other via node C, md.sa=C) will be initially treated as a non-duplicate by the routing protocol at the base-station. This is because duplicate messages arriving over multiple disjoint paths contain valuable information about the state of the other links in the network. However the link-break-counter, md.l, must be decremented by one since that link-break-event will have already been accounted for by another packet. Also, if the paths are convergent within the network any duplicate packets will be suppressed before reaching the base station.

Algorithm 4 Data Forwarding with Lateral transmission

DataIncoming(Message md)

if (md is duplicate)

delete(md)

else if (md.h > h)

DataForwarding(md)

else if (md.lt > 0)

(md.lt=md.lt − ((h − md.h) + 1))
if (md.lt ≧0)

DataForwarding(md)

else

delete(md)

DataForwarding(Message md)

if (p ≠ NULL)

md.h = h
DataForwardingTreeMechanism(md)

else

md.h = HMAX
DataForwardingFloodMechanism(md)

DataForwardingTreeMechanism(Message md)

md.sa = localaddr
md.da = p
new AckTimer(t_{ack},md)
send(mt, ACK)

DataForwardingFloodMechanism(Message mt)

md.sa = localaddr
md.da = bcaddr
md.l = md.l + 1
send(mt)

ACKTimerExecuted(Message md)

if (transmissions >= MAXtx)

DataForwardingFloodMechanism(md)

else

transmissions = transmissions+1
DataForwardingTreeMechanism(md)

ACKMessageReceived(Message md)

deleteACKTimer(md)

Algorithm 5 Routing variables (Implemented at the base-station)

DataIncoming(Message md)

l = 0

}

Algorithm 6 Data reception (Implemented at the base-station)

DataIncoming(Message md)

if (md is duplicate AND md.sa ==duplicate md.sa)

delete(md)

else

if (md is duplicate)

md.l = (md.l − 1)

l = l + md.l
if(l > LMAX)

l = 0
TopologyDiscovery(new Message)

if (md is duplicate)

delete(md)

else

ProcessData(md)

TopologyTimerExecuted( )

l = 0
new TopologyTimer(t_{topology})
TopologyDiscovery(new Message)

If the message is not a duplicate or has arrived via a disjoint path, the link-break counter is updated. The number of link-break events detected during the transmission of the packet is contained in the data message variable md.l. This variable is added to the base-station variable l. If the link-break-counter l reaches a threshold defined by LMAX, the topology is refreshed by calling the previously described function TopologyDiscovery. LMAX is used to control how badly a topology can be damaged before a topology rebuild is initiated.

Periodically, the function TopologyTimerExecuted is called. The frequency is defined by t_{topology}. Thus, a periodic topology rebuild is initiated. This function is necessary as a broken topology might not deliver any message (not even through the directed flooding) and LMAX is not reached.

Finally it is checked again if the message and is a duplicate. All duplicated are silently discarded at this stage regardless of whether they arrived via disjoint path.

### Local Rebuilding

In a number of cases it may be more efficient to initiate a local rebuilding policy rather than rebuilding the entire network. This is particularly useful where the network is relatively stable but prone to localised failures and when the network is very large. The operation is essentially the same as that used by the base-station 2 to rebuild the topology. In this case a parent node must detect if a child node has become disconnected. This can be done by recording the time since the last communication from neighbour i was received whereupon the timer function LinkTimer(md.sa,TMAX) is called. TMAX is a predefined maximum and md.sa is the node identifier of a neighbouring node. At any given time there may be several timers running, one for each direct child node in the routing tree. A parent node discovers his child nodes when non-flooded messages arrive from them. As the messages arrive a list is built. When more messages arrive from nodes already in the list their timer is reset. All timers in the list are deleted using the function deleteLinkTimers( ) whenever the topology undergoes a rebuild. Should the function LinkTimerExecuted( ) be called the route rebuilding should initiate and the function TopologyDiscovery{Message mt} is called. At this point all link timers are deleted. Unlike the base-station, the variable 1 is not used to determine if a topology rebuild should occur since this variable will not be incremented as flooded packets will not be successfully transmitted over the broken link. The topology discovery message variables are set as follows: mt.s=s and mt.h=h. Therefore the message will only be forwarded by child nodes and the current topology sequence number is used.

For clarity, the protocol as described above, using a routing mechanism and selectively using a flooding mechanism when failures are detected, is termed a “Full Mechanism”. However, frequent topology rebuilding is undesirable and in deteriorating network conditions a situation can arise where a routing tree is constantly rebuilding. In this case it is better to use a Flood Mode or a Restricted Flood Mode as discussed below.

### Flood Mode

The network operates in a Flood Mode, in which it does not employ a routing mechanism._Every message is forwarded using DataForwardingFloodMode directly. This might be necessary if the transceiver does not support an acknowledgement mechanism and link breaks can not be detected by other means. This operation method might also be useful if the link breaks are occurring frequently and a distribution of topology discovery messages along the tree is nearly impossible.

Algorithm 7 Local rebuilding (Implemented at each node)

DataIncoming(Message md)

if (md is duplicate)

delete(md)

else if (md.h > h)

if (md.da = localaddr)

LinkTimer(md.sa,TMAX)

DataForwarding(md)

else if (md.lt > 0)

(md.lt=md.lt − ((h − md.h) + 1)
if (md.lt ≧0)

if (md.da = localaddr)

LinkTimer(md.sa,TMAX)

DataForwarding(md)

else

delete(md)

LinkTimerExecuted( )

deleteLinkTimers( )
TopologyDiscovery(new Message)

### Restricted Flood Mode

This mode includes the features of the Flood Mode, but additionally, the tree building mechanism used by the base station is not performed. Instead, the hop distance variable h in each node is set manually before deployment. In this case, the network can operate without periodically exchanging the topology building message. This would be particularly suitable for small networks.

### Switching Operation Modes During Runtime

It may be useful under deteriorating network conditions to switch operation modes during run-time. Consider the case where LMAX is frequently exceeded triggering topology rebuilding. If LMAX is exceeded excessively it is advisable to abandon the use of tree mode since it is apparent that the network conditions cannot support tree mode. Rather than constantly trying to rebuild the topology the network can be instructed via control message from the base-station to use Restricted Flood mode or Flood Mode as the mode of transmission.

It is also possible for a node to individually switch modes during runtime. In this scenario a variable, l_{local} must be kept at each node to indicate how many link breaks have occurred since the last topology message. If this value exceeds another node variable LMAX_{local} the node will switch into Flood Mode until a new topology message arrives whereupon it will revert to tree mode once more.

Algorithm 8 Topology discovery with local
rebuild (Implemented at each node)

TopologyDiscovery(Message mt)

if (t.s = s)

if(mt.h < h)

h = mt.h
p = mt.sa
mt.sa = localaddr
mt.da = bcaddr
mt.h = mt.h + 1
send(mt)
deleteLinkTimers( )

else

delete(mt)

else if (mt.s > s)

s = mt.s
h = mt.h
p = mt.sa
mt.sa = localaddr
mt.da = bcaddr
mt.h = mt.h + 1
send(mt)
deleteLinkTimers( )

else

delete(mt)

The communication method of the invention operates well in conditions with changing link qualities. In addition, the protocol is simple and easy to debug. The following are some potential problems and how they are solved.

### Asymmetric Links

A node A might be able to transmit a message to node B but B is unable to send a message to node A. In this case, acknowledgements might be lost and the link will be detected as broken. However, the original message will be delivered through the tree structure and additional copies of the message might be delivered using the flooding mechanism. Therefore, packets are not lost.

### Local Rebuilding

Use of local rebuilding can leave the network in an unstable state and may trigger off successive rounds of local rebuilding without end. Consider the following case. Node C has two possible parents' nodes A and B, both of whom are equidistant to the base-station. Node C has node A as a parent when node B initiates a local rebuild. Node C will then switch parents to node B. Some time later node A will detect that node C has not communicated with it and initiate a local rebuild. Node C will again switch parents to node A. Node B will detect that node C has not communicated with it and initiate a local rebuild. This process will continue until a new Topology Discovery Message is sent from the base-station. This problem can be solved by limiting the amount of times a node can change parents in between each Topology Discovery Message sent from the base-station.

The invention is not limited to the embodiments described but may be varied in construction and detail.

1. A wireless network comprising a plurality of nodes having transmitters and receivers and being interconnected by links, the nodes being adapted for sending data packets containing a payload so that it is routed through the network, wherein at least some nodes comprise means for:
using either a routing mechanism based on a stored network topology or a flooding mechanism for sending data packets containing a payload to a destination node in the network, and
dynamically switching in real time for data delivery from the routing mechanism to the flooding mechanism if a link failure is detected.

2. A wireless network as claimed in claim 1, wherein said nodes dynamically employ the flooding mechanism for sending data packets containing payload without topology re-build of the routing mechanism on the next occasion.

3. A wireless network as claimed in claim 1, wherein the flooding mechanism of at least some nodes only direct data laterally to nodes which are an equal number of links from a sink node as the sending node.

4. A wireless network as claimed in claim 1, wherein the flooding mechanism of at least some nodes directs data laterally to nodes which are an equal number of links from a sink node as the sending node, and wherein at least some nodes maintain a count indicating lateral transmissions.

5. A wireless network as claimed in claim 1, wherein a lateral transmission count is included with transmitted data, and a receiving node re-transmits if the lateral transmission count does not indicate that there have been an excessive number of lateral transmissions, wherein the lateral transmission count is updated with each transmission, such that the lateral transmission count is updated by decrementing it if a lateral transmission is made.

6. A wireless network as claimed in claim 1, wherein a lateral transmission count is included with transmitted data, and a receiving node re-transmits if the lateral transmission count does not indicate that there have been an excessive number of lateral transmissions, wherein the lateral transmission count is updated with each transmission, such that the lateral transmission count is updated by decrementing it if a lateral transmission is made, wherein said receiving node is adapted to decide according to comparison of the lateral transmission count value with a threshold which is common across all of the nodes.

7. A wireless network as claimed in claim 1, wherein a lateral transmission count is included with transmitted data, and a receiving node re-transmits if the lateral transmission count does not indicate that there have been an excessive number of lateral transmissions, wherein the lateral transmission count is updated with each transmission, such that the lateral transmission count is updated by decrementing it if a lateral transmission is made, and wherein said receiving node is adapted to decide according to comparison of the lateral transmission count value with a threshold which is per-node, being set according to the number of hops between the node and a destination node.

8. A wireless network as claimed in claim 1, wherein a lateral transmission count is included with transmitted data, and a receiving node re-transmits if the lateral transmission count does not indicate that there have been an excessive number of lateral transmissions, wherein the lateral transmission count is updated with each transmission, such that the lateral transmission count is updated by decrementing it if a lateral transmission is made, and wherein said receiving node is adapted to decide according to comparison of the lateral transmission count value with a threshold which is per-node, being set according to the number of hops between the node and a destination node,-said receiving node is adapted to determine the threshold according to the number of hops to the destination node for the data.

9. A wireless network as claimed in claim 1, wherein at least some nodes maintain a link-break counter and at least some nodes automatically perform topology re-build if the link-break parameter value is exceeded.

10. A wireless network as claimed in claim 1, wherein at least some nodes maintain a link-break counter and at least some nodes automatically perform topology re-build if the link-break parameter value is exceeded the link-break parameter is per node and said nodes update the counter upon each detection of a link break.

11. A wireless network as claimed in claim 1, wherein at least some nodes maintain a link-break counter and at least some nodes automatically perform topology re-build if the link-break parameter value is exceeded, wherein the parameter is time, topology discovery being performed periodically.

12. A wireless network as claimed in claim 1, wherein said nodes maintain a sequence number of a current valid topology.

13. A wireless network as claimed in claim 1, wherein at least some nodes detect a link break if an acknowledgement is not received from a node to which it has sent data.

14. A wireless network as claimed in claim 1, wherein at least some nodes maintain a variable, h, of the distance in links between the node and another node, and for using said parameter for the routing mechanism, wherein the other node is a base station.

15. A wireless network as claimed in claim 1, wherein at least some nodes store an address of a parent node and use said address for the routing mechanism.

16. A wireless network as claimed in claim 1, wherein the network comprises a base station node managing topology maintenance for the nodes, the base station node transmitting to each node via the network an address of a parent node and a maximum hop distance to the base station node.

17. A wireless network as claimed in claim 1, wherein at least some nodes incorporate sensors and means for sending sensed data, and at least one node is a base station for collecting said data, the network comprises means for changing from a full mode in which there is dynamic switching from a routing mechanism to a flooding mechanism, to a flooding mode in which a flooding mechanism is always employed.

18. A wireless network as claimed in claim 1, wherein the flooding mechanism of a flooding mode is a restricted flooding mechanism in which there is no topology re-building.

19. A wireless network as claimed in claim 1, wherein the network changes to the flooding mode if an excessive number of link failures is detected.

20. A wireless network as claimed in claim 1, wherein at least one node changes mode individually on a per-node basis.

21. A wireless network as claimed in claim 1, wherein the payload is data generated by a sensor.

22. A wireless network comprising a plurality of nodes having transmitters and receivers and being interconnected by links, the nodes being adapted for sending data packets containing a payload so that it is routed through the network, wherein at least some nodes comprise means for:
using either a routing mechanism based on a stored network topology or a flooding mechanism for sending data packets containing a payload to only lateral destination nodes in the network which are an equal number of links from a sink node as the sending node, and
dynamically switching in real time for data delivery from the routing mechanism to the flooding mechanism if a link failure is detected,
wherein at least some nodes maintain a link-break counter and at least some nodes automatically perform topology re-build if the link-break parameter value is exceeded.

23. A wireless network as claimed in claim 22, wherein said nodes maintain a sequence number of a current valid topology.
